(19) United States
(12) Patent Application Publication
(10) Pub. No.: US 2013/0062397 A1
(43) Pub. Date: Mar. 14, 2013

(54) METHOD FOR WELDING TOGETHER TWO PLANAR COMPONENTS

(71) Applicants: Dieter Stroh, Wettenberg (DE); Heiko Stroh, Wettenberg (DE)

(72) Inventors: Dieter Stroh, Wettenberg (DE); Heiko Stroh, Wettenberg (DE)

(73) Assignee: SCHUNK SONOSYSTEMS GMBH, Wettenberg (DE)

(21) Appl. No.: 13/640,274

(22) PCT Filed: Apr. 8, 2011
(86) PCT No.: PCT/EP2011/055527

§ 371 Date: Nov. 9, 2012

(30) Foreign Application Priority Data
Apr. 9, 2010 (DE) 102010016391.0
Apr. 13, 2010 (DE) 102010016415.1

(51) Int. Cl. B23K 20/10

(52) U.S. Cl. CPC B23K 20/10
USPC 228/110.1

(57) ABSTRACT

A method for welding together at least two planar metal components oriented with respect to one another using ultrasound, wherein for the welding operation the components are arranged between a tool transmitting ultrasonic vibrations and a counter-holder and fixed between same by the application of pressure. In order for the components to have a desired orientation with respect to one another after the welding operation that corresponds to the orientation prior to the welding operation, according to the invention the components, prior to applying the ultrasonic vibrations for welding the same together, are deformed by means of at least one projection that projects from the tool and/or the counter-holder beyond the respective working surface using the application of force such that a translatable and rotatable relative movement is suppressed, or substantially suppressed, between the components and that the welding operation is carried out after the deformation.

The invention involves a procedure for welding at least two flat metal structural components aligned with each other, such as metal strips, using ultrasound, whereby for purposes of welding the pieces are set in place between a tool transmitting ultrasound pulses and a holding piece and are force actuated by these.

In order to solidly bind the materials of the flat metal structural components using metal ultrasound soldering, the materials are set up between a tool called a Sonotrode, which transmits ultrasound pulses, and an anvil or counter electrode, called a holding piece. The structural components are fixed in place between the Sonotrode and the anvil by exerting pressure, whereby the ultrasound pulses necessary for the welding are transmitted via the Sonotrode. In this regard it has been past experience that through the ultrasound pulses a relative movement between the components in particular occurs if more than 2 flat structural components are to be welded to one another, and as a result a desired alignment of these is not assured, since the outer structural components can be fixed in place through the standard structured work surfaces by the Sonotrode and the anvil, as opposed to the structural component or components that are set up between the outer pieces, which can be moved out of position.

This invention has the task of solidly binding together flat metal structural components using ultrasound welding, whereby the structural components are to have a desired post-welding alignment to each other that matches the pre-welding alignment.

As a solution to this task, the invention essentially envisages that the projection existing from at least the tool and/or the holding piece over the particular work surfaces to be welded by the application of ultrasound pulses will upon application of force be deformed in a way that a translating and rotary relative movement between these is prevented or mainly prevented, and after the deformation the welding is performed.

According to the invention, structural components like metal strips are fixed in place in a way that initially a deformation of the strips between the tool (hereinafter also called the Sonotrode) and the holding piece (hereinafter also called the anvil) occurs, whereby it is assured that during the actual welding process, in which the Sonotrode pulses parallel to the structural components, the strips are not dislocated from each other.

In order to facilitate the deformation, when the Sonotrode and anvil are moved relative to one another and when the structural components are fixed in place by the application of force, an ultrasound impulse can be created that is not part of the welding procedure.

The possibility also arises that pre-positioning the flat structural components to be welded, such as metals, can occur in a way that these are drilled with holes ahead of time, whereby for welding the holes can be aligned temporarily with one another and so that at least one projection grabs hold of these in order to expand the holes and thus allow the mechanical deformation for fixing in place the flat structural components in relation to one another.

If only one projection is envisaged, then this must preferentially have a linear extension in order to prevent to the desired extent both the translating and the rotating relative movement.

In particular, however, it is envisaged that two projections separated from each other will exist that can have a geometry such as of a cone or a pyramid or a cylindrical form or other geometrical form.

If a cylindrical projection is used, this should have a point or a tapering at one end in order to facilitate the mechanical deformation of the flat structural components.

Regardless of this, the possibility exists that the structural components are fixed in place over at least one but preferentially two of the projections from the tool.

Alternatively, the structural components can be fixed over at least one and preferentially over two projections from the anvil.

The possibility also exists that a projection from the Sonotrode and a projection from the anvil protrude, allowing the necessary deformation of the structural components to fix them in place relative to one another.

In a further development of the invention, it is suggested that a cutout in the work surface of the holding piece or of the tool be set up to match the projection in the tool or in the holding piece. These measures are in particular necessary if the total thickness of the structural components to be welded is small in comparison to the height of the projection; then it must be assured that during the welding the projection does not hit a work surface, whereby otherwise a proper welding is not possible.

As materials for the flat metal structural components, those that are standard for metal ultrasound welding are to be considered, preferentially copper, copper alloys, surface coated materials such as copper or copper alloys coated with nickel, aluminum, or aluminum alloys.

The pieces of metal can have variable thicknesses, whereby the metal thicknesses are preferred in the range between 0.01 mm and 1 mm.

In particular more than two structural components are welded without having the interior structural components relative to the others being pushed out of place, since the structural components are almost interlocked with each other through the deformations for the ultrasound welding.

Other details, advantages, and characteristics of the invention can be taken not only from the claims and from the characteristics resulting from these in themselves and/or in combination with each other, but also from the preferred embodiments that can be taken from the following description of the drawing.

The following are shown:

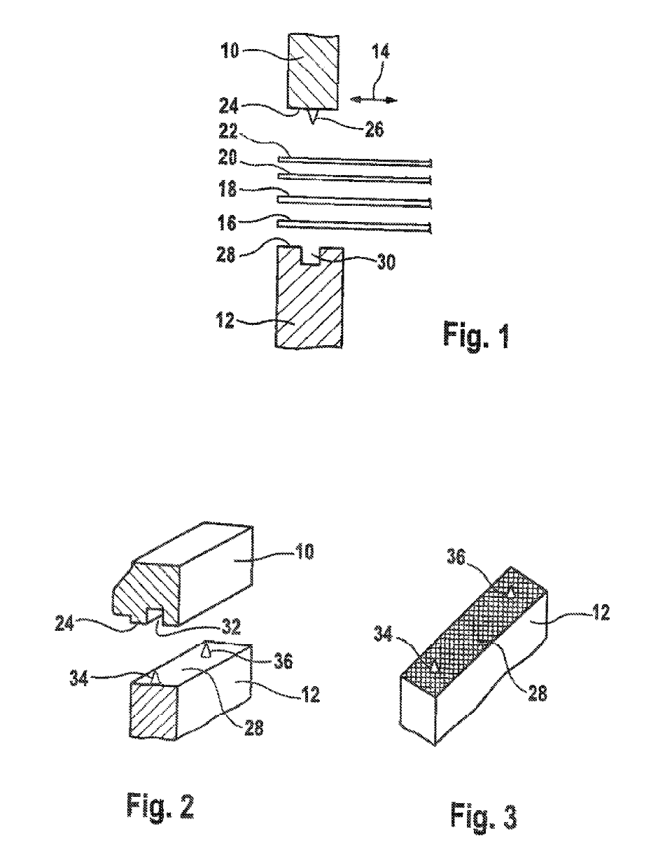

FIG. 1 a first embodiment of the tool and a holding piece of an ultrasound welding device in a cut out,

FIG. 2 a cut out of a second embodiment of an ultrasound welding device and

FIG. 3 a detail of FIG. 2.

From the figures, using essentially the same reference labels used for equivalent elements as do are cutouts from well-known specific ultrasound welding devices. These include in a known manner a Sonotrode 10 with a Sonotrode head and an anvil 12 assigned to it. The Sonotrode 10 can be connected with a converter via a booster in order to set the Sonotrode and thereby the Sonotrode head pulsing. The direction of the pulse is indicated by the double arrow 14. A principal construction of an ultrasound welding device with essential components may be taken from FIG. 1 of WO-A-2008/148813, the publication of which is a component of this filing.

In order to weld flat metal structural components such as metal strips 16, 18, 20, 22 with each other, these are aligned between the anvil 12 and the Sonotrode 10, and between work surfaces 24, 28 of these, which are structured in a standard manner. One recognizes in the principal presentation that the metal strips 16, 18, 20, 22 are set parallel or approximately parallel to the swinging direction of the Sonotrode 10.

The metal strips 16, 18, 20, 22 can for example be made of copper, a copper alloy, a surface coated metal, aluminum, or aluminum alloys. Other known materials for metal ultrasound welding may also be considered.

Since the Sonotrode 10 pulses parallel to the tensioned planes of the metal strips 16, 18, 20, 22, in order to prevent the metal strips 16, 18, 20, 22 from sliding away from each other during the transmission of the ultrasound pulses, according to the invention it is envisaged that before the actual welding process the metal strips 16, 18, 20, 22 are fixed in place toward each other after being aligned with each other. This occurs through mechanical deformation. For this, according to the embodiment example of FIG. 1 it is envisaged that at least one projection 26 protrudes from the Sonotrode 10 or from the welding or work surface 24.

The Sonotrode 10 preferentially in cross-section has a right angle geometry, which extends perpendicular to the longitudinal axis of the Sonotrode. The opposite narrow sides of the Sonotrode head making a square form the work surfaces, from which projections can protrude according to the teaching of the invention.

When the Sonotrode 10 is dropped onto the metal 16, 18, 20, 22, which lie on the work surface 28 of the anvil 12, the pieces of metal 16, 18, 20, 22 are deformed in a way that an interlinking or perforation with each other follows and in this way a relative movement is excluded. Thereby not only a translating relative movement but also a rotating relative movement is prevented so that the desired defined position of for example the edges of the metal strips 16, 18, 20, 22 are aligned with each other to the desired extent even after the welding process. In the embodiment example it should be assured that the front edges of the welded metal strips 16, 18, 20, 22 run flush against each other.

To prevent the relative movement, in the embodiment example according to FIG. 1, either a linear projection 26 or at least two separate and if necessary pointed projections protrude from the work or welding surface 24 of the Sonotrode 10, so that a translating and rotating relative movement is excluded after the deformation of the metal strips 16, 18, 20, 22.

As results from the presentation in FIG. 1, a cutout 30 or 2 cutouts in the work surface 28 of the anvil 12 are set up opposite the projection 26 or the projections of the Sonotrode 10 that are set over the work surface 24, so that during welding, the point of the projection 26 does not hit the work surface 28, whereby otherwise a proper welding would not be possible. It is obvious that several projections can grab onto a continuous cutout.

A corresponding cutout 30 is obviously then not necessary if the total thickness of the metal is sufficient so that a complete penetration of the projection 26 is not possible during welding.

In order to facilitate the deformation, the possibility exists that after setting the Sonotrode 10 on the metal strips 16, 18, 20, 22 lying on the anvil 12, the Sonotrode 10 will experience a short ultrasound impulse.

The possibility also exists of allowing through a pre-positioning of the metal strips 16, 18, 20, 22 for the metal strips 16, 18, 20, 22 to have holes put in them so that the holes are temporarily aligned with each other during welding, and the projection or the projections that protrude from the Sonotrode 10 or the anvil 12 are aligned with these.

The embodiment example of FIG. 2 is different from that in FIG. 1 in that the Sonotrode 10 or its head have a cutout or a hollow in the work surface 24 to which the positioned protrusions 34, 36 are set to stand over the work surface 28 of the anvil 12. Thereby it is not necessary that in the work surface 24 of the anvil 12 separate cutouts 32 for each projection 34, 36 be envisaged. Rather a complete cutout can be envisaged as a groove. The same applies to the embodiment of FIG. 1.

FIG. 3 again shows clearly that the projections 34, 36 protrude over the structured work surface 28 of anvil 12.

Alternatively to the presented embodiments and the possibility that a linear projection protrudes from the anvil 12 or the Sonotrode 10, the possibility exists that a projection protrudes over the work surface 28 of the anvil 12 and a protrusion protrudes over the work surface 24 of the Sonotrode 10. In this way it is also assured that the flat structural components like metal strips 16, 18, 20, 22 are deformed toward each other and thereby fixed in place so that a relative movement to each other does not occur during ultrasound welding.

1. Procedure for welding at least two flat metallic structural components (16, 18, 20, 22) aligned with each other, such as metal strips, using ultrasound, whereby for welding the structural components are arranged between the tool (10) transmitting the ultrasound pulses and a holding piece (12) and are fixed in place through the exertion of force, so characterized in that the structural components (16, 18, 20, 22) before welding by the application of ultrasound pulses have at least one projection (26, 34, 36) projecting from the tool (10) and/or the holding part (12) over the particular work surface (24, 28) applied for welding and are deformed by the exertion of force in a way that a translating and rotating relative movement between the parts is prevented or essentially prevented, and the welding is done after the deformation.

2. Procedure according to claim 1, so characterized in that the structural components (16, 18, 20, 22), are deformed by at least 2 protrusions (34, 36).

3. Procedure according to claim 1, so characterized in that the structural components (16, 18, 20, 22) are deformed by the at least one and preferentially two protrusions (26) protruding from the tool (10) or that the structural components are deformed by the at least one and preferentially two protrusions (34, 36) protruding from the holding piece (12).

4. Procedure according to claim 1, so characterized in that the structural components (16, 18, 20, 22) are deformed by the at least one protrusion protruding from the tool (10) and at least one protrusion protruding from the holding piece (12).

5. Procedure according to claim 1, so characterized in that a cutout (30, 32) in the work surface (24, 28) in the holding piece or in the tool is set up to match the protrusion (26, 34, 36) in the tool (10) or the holding piece (12).

6. Procedure according to claim 1, so characterized in that at least 3 and preferentially more than 3 flat structural components (16, 18, 20, 22) aligned with each other are welded.

7. Procedure according to claim 1, so characterized in that the structural components (16, 18, 20, 22) to be welded temporarily have cutouts aligned with each other, onto which the protrusion (26, 34, 36) is aligned in order to widen the cutouts.

8. Procedure according to claim 1, so characterized in that the flat structural components (16, 18, 20, 22) that are welded to each other have thicknesses in the range between 0.01 mm and 1 mm.

9. Procedure according to claim 1, so characterized in that the flat structural components (16, 18, 20, 22) to be welded have thicknesses differing from each other.

10. Procedure according to claim 1, so characterized in that the structural components (16, 18, 20, 22) are deformed by at least one protrusion causing a linear deformation.

11. Procedure according to claim 1, so characterized in that the structural components (16, 18, 20, 22) are deformed by protrusions (26, 34, 36) that have the geometry of a cone, of a truncated cone, a pyramid, a truncated pyramid, or a cylinder preferentially with a point on the end.

12. Procedure according to claim 1, so characterized in that the flat structural components (16, 18, 20, 22) are aligned with each other in such a way that they can be welded with one edge temporarily aligned.

13. Procedure according to claim 1, so characterized in that a Sonotrode is used as a tool (10), on which a Sonotrode head having a work surface (24) is formed at a right angle when running in a plane perpendicular to the pulsing axis.
